(19) United States
(12) Patent Application Publication
(10) Pub. No.: US 2026/0097756 A1
(43) Pub. Date: Apr. 9, 2026

(54) AUTOMATED PARKING

(71) Applicant: JAGUAR LAND ROVER LIMITED, Whitley, Coventry, Warwickshire (GB)

(72) Inventor: Belman Achutha Sreedhar THANTHRY, Whitley, Coventry, Warwickshire (GB)

(21) Appl. No.: 19/131,877

(22) PCT Filed: Nov. 16, 2023
(86) PCT No.: PCT/EP2023/082085

§ 371 Date: May 21, 2025

(30) Foreign Application Priority Data
Nov. 21, 2022 (GB) 2217373.6

(51) Int. Cl. B60W 30/06; B60W 30/08; B60W 30/09; B60W 30/095; B62D 15/02; G06V 20/56

(52) U.S. Cl. CPC B60W 30/06; B60W 30/09; B60W 30/095; B62D 15/0285; G06V 20/56; B60W 2030/082; B60W 2420/403; B60W 2554/60

(57) ABSTRACT

A control system for a vehicle, configured to: receive image data; determine, in dependence on received image data, that a kerb is in the vicinity of the vehicle during an automated parking manoeuvre; determine whether a projected path of the parking manoeuvre will cause the vehicle to strike the kerb; when it is determined that the projected path of the parking manoeuvre will not cause the vehicle to strike the kerb, output a control signal to control the vehicle to proceed with the parking manoeuvre; and when it is determined that the projected path of the parking manoeuvre will cause the vehicle to strike the kerb, output a control signal to control performance of one or more actions to prevent a non-user authorised vehicle kerb strike.

### CROSS REFERENCE TO RELATED APPLICATIONS

The present application is a U.S. National Phase of International Application No. PCT/EP2023/082085 entitled “AUTOMATED PARKING,” and filed on Nov. 16, 2023. International Application No. PCT/EP2023/082085 claims priority to Great Britain Patent Application No. 2217373.6 filed on Nov. 21, 2022. The entire contents of each of the above-listed applications are hereby incorporated by reference for all purposes.

### TECHNICAL FIELD

The present disclosure relates to automated parking. In particular, but not exclusively, it relates to a control system, vehicle, method, and computer software for automated parking.

### BACKGROUND

Some vehicles can perform automated parking manoeuvres. However, automated parking manoeuvres may not be performed intelligently.

It is an aim of the present invention to address one or more of the disadvantages associated with the prior art.

### SUMMARY OF THE INVENTION

Aspects and embodiments of the invention provide a control system, a vehicle, a method and computer software as claimed in the appended claims.

According to an aspect of the invention there is provided a control system for a vehicle, the control system comprising one or more controllers, wherein the control system is configured to:
receive image data;
determine, in dependence on, at least, the received image data, that a kerb is in the vicinity of the vehicle during an automated parking manoeuvre;
determine whether a projected path of the automated parking manoeuvre of the vehicle will cause the vehicle to strike the kerb;
when it is determined that the projected path of the automated parking manoeuvre of the vehicle will not cause the vehicle to strike the kerb, output at least one control signal to control the vehicle to proceed with the automated parking manoeuvre; and
when it is determined that the projected path of the automated parking manoeuvre of the vehicle will cause the vehicle to strike the kerb, output at least one control signal to control performance of one or more actions to prevent a non-user authorised vehicle kerb strike.

A non-user authorised vehicle kerb strike means that the user is not aware that a curb strike is about to occur until it occurs. This control system provides the advantage that the vehicle is prevented from striking a kerb during an automated parking procedure without driver/user knowledge and/or approval.

In some examples, the control system is configured to:
output at least one control signal to control performance of one or more actions in dependence on determining that at least one wheel of the vehicle has struck a kerb during the automated parking manoeuvre.

This provides the advantage that the vehicle can react appropriately if a kerb is struck during an automated parking manoeuvre.

In some examples, the control system is configured to, when it is determined that the projected path of the automated parking manoeuvre will cause the vehicle to strike a kerb or that at least one wheel of the vehicle has struck a kerb, determine if the projected path of the vehicle can be changed to avoid the kerb.

This provides the advantage that a kerb is avoided if possible. This applies also in the case of the kerb having been struck and the vehicle rebounding from it.

In some examples, the control system is configured to, when it is determined that the projected path can be changed to avoid the kerb, change the projected path of the automated parking manoeuvre of the vehicle to avoid the kerb.

This provides the advantage that the kerb is automatically avoided if possible.

In some examples, the control system is configured to, when it is determined that the projected path cannot be changed to avoid the kerb, interrupt the automated parking manoeuvre and provide at least one output to at least one user of the vehicle informing the user of an imminent kerb strike.

This provides the advantage that a user/driver is informed prior to a kerb strike

In some examples, the control system is configured to provide to the user, an option to proceed with the automated parking manoeuvre or switch to a manual driving mode.

In some examples, the at least one kerb delimits at least one edge of a parking slot.

In some examples, the control system is configured to determine that at least one kerb is in the vicinity of the vehicle during an automated parking manoeuvre in dependence on, at least, image data and ultrasonic data.

In some examples, the control system is configured to determine that at least one side edge of a potential parking slot is not delimited and to position a virtual object to create an artificial demarcation to define an area to be avoided by the vehicle during the automated parking manoeuvre.

In some examples, the control system is configured to, when it is determined that the projected path of the automated parking manoeuvre will cause the vehicle to strike a kerb or that at least one wheel of the vehicle has struck a kerb, extend the kerb virtually as a line for delimiting the parking slot.

In some examples, the control system is configured to reposition the virtual object to cover the extended kerb, while aligning the repositioned virtual object with a front edge of a parking slot that the vehicle is manoeuvring into.

In some examples, the one or more controllers collectively comprise:
at least one electronic processor having an electrical input for receiving information associated with and/or for use in automated parking, for example image data and/or ultrasonic data; and
at least one memory device electrically coupled to the electronic processor and having instructions stored therein;
and wherein the electronic processor is configured to access the memory device and execute the instructions thereon so as to perform and/or cause performance of any one or more methods described herein.

According to a further aspect of the invention, there is provided a vehicle comprising a control system as described herein and at least one camera configured to output the image data.

According to a further aspect of the invention, there is provided a method of controlling a vehicle, the method comprising:
receiving image data;
determining, in dependence on, at least, the received image data, that a kerb is in the vicinity of the vehicle during an automated parking manoeuvre;
determining whether a projected path of the automated parking manoeuvre of the vehicle will cause the vehicle to strike the kerb;
when it is determined that the projected path of the automated parking manoeuvre of the vehicle will not cause the vehicle to strike the kerb, outputting at least one control signal to control the vehicle to proceed with the automated parking manoeuvre; and
when it is determined that the projected path of the automated parking manoeuvre of the vehicle will cause the vehicle to strike the kerb, outputting at least one control signal to control performance of one or more actions to prevent a non-user authorised vehicle kerb strike.

In some examples, the method comprises, when it is determined that the projected path of the automated parking manoeuvre will cause the vehicle to strike a kerb, determining if the projected path of the vehicle can be changed to avoid the kerb.

In some examples, the method comprises, when it is determined that the projected path can be changed to avoid the kerb, changing the projected path of the automated parking manoeuvre of the vehicle to avoid the kerb.

In some examples, the method comprises, when it is determined that the projected path cannot be changed to avoid the kerb, interrupting the automated parking manoeuvre and providing at least one output to at least one user of the vehicle informing the user of an imminent kerb strike.

In some examples, the method comprises providing to user, an option to proceed with the automated parking manoeuvre or switch to a manual driving mode.

In some examples, the method comprises determining that at least one kerb is in the vicinity of the vehicle during an automated parking manoeuvre in dependence on, at least, image data and ultrasonic data.

In some examples, the method comprises determining that at least one side edge of a potential parking slot is not delimited wherein the method defined above is performed in dependence on the determination that at least one side edge of a potential parking slot is not delimited.

According to a further aspect of the invention there is provided computer software that, when executed, is arranged to perform any one or more of the methods described herein.

According to a further aspect of the invention there is provided a non-transitory computer readable medium comprising computer readable instructions that, when executed by one or more electronic processors, causes the one or more electronic processors to carry out any one or more of the methods described herein.

Within the scope of this application it is expressly intended that the various aspects, embodiments, examples and alternatives set out in the preceding paragraphs, in the claims and/or in the following description and drawings, and in particular the individual features thereof, may be taken independently or in any combination that falls within the scope of the appended claims. That is, all embodiments and/or features of any embodiment can be combined in any way and/or combination that falls within the scope of the appended claims, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings, in which:

FIG. 1 illustrates an example of a vehicle;

FIGS. 2A and 2B illustrate an example of a control system and of a non-transitory computer readable storage medium;

FIG. 3 illustrates an example of a method;

FIG. 4 illustrates an example of a parking slot; and

FIGS. 5A and 5B illustrate an example of an automated parking manoeuvre.

### DETAILED DESCRIPTION

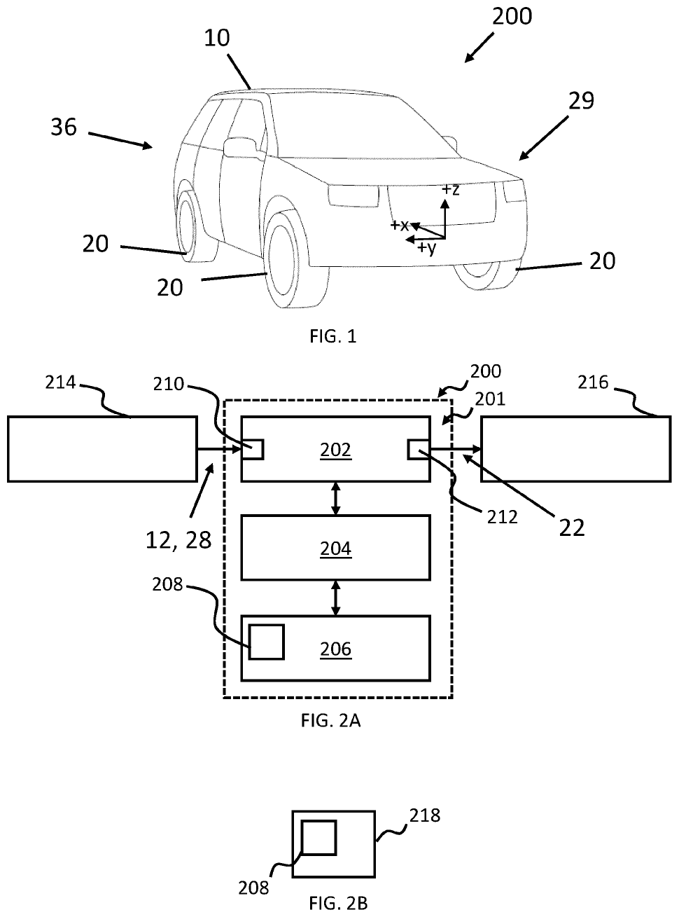

FIG. 1 illustrates an example of a vehicle 10 in which embodiments of the invention can be implemented. In some, but not necessarily all, examples the vehicle 10 is a passenger vehicle, also referred to as a passenger car or as an automobile. In other examples, embodiments of the invention can be implemented for other applications, such as commercial vehicles.

FIG. 1 is a front perspective view and illustrates a longitudinal x-axis between the front and rear of the vehicle 10 representing a centreline, an orthogonal lateral y-axis between left and right lateral sides of the vehicle, and a vertical z-axis. A forward/fore direction typically faced by a driver's seat is in the negative x-direction; rearward/aft is +x. A rightward direction as seen from the driver's seat is in the positive y-direction; leftward is −y. These are a first lateral direction and a second lateral direction.

The vehicle 10 comprises a control system 200 comprising one or more controllers (see, for example, FIG. 2A) configured to control, for example, one or more functions and/or features of the vehicle 10.

In the example of FIG. 1, the vehicle 10 comprises one or more cameras 36.

A camera 36 can be considered a visual and/or visible light spectrum camera. A camera 36 can be considered to provide information/data to image processors implementing computer vision algorithms.

In examples, a camera 36 can be considered to operate in the visible light frequency range, for example in the range 430 to 790 THz.

In examples, a camera 36 can be considered to be configured to provide and/or produce image data, for example of the environment of the vehicle 10.

Consequently, FIG. 1 illustrates an example of a vehicle 10 comprising a control system 200 as described herein and at least one camera 36 configured to output image data 12.

In the example of FIG. 1, the vehicle 10 comprises one or more ultrasonic sensors 29.

In examples, an ultrasonic sensor 29 can be considered a sensor configured to emit one or more sound waves in the ultrasonic frequency range and/or to detect reflected sound waves in the ultrasonic frequency range.

In examples, an ultrasonic sensor 29 can be considered to operate in the ultrasonic frequency range, for example in the frequency range 30 to 500 kHz.

In some examples, an ultrasonic sensor 29 can be considered to operate in the frequency range 30 to 80 kHz.

In examples, an ultrasonic sensor 29 can be considered to be configured to provide and/or produce ultrasonic data 28.

The vehicle 10 also comprises a plurality of wheels 20.

The control system 200 is configured to implement, at least part of, any one or more of the methods described herein.

FIGS. 2A and 2B illustrate an example control system 200 configured to implement one or more aspects of the invention. The control system 200 of FIGS. 2A and 2B comprise a controller 201. In other examples, the control system 200 may comprise a plurality of controllers on-board and/or off-board the vehicle 10.

In examples, any suitable control system 200 can be used.

The controller 201 of FIGS. 2A and 2B include at least one processor 204; and at least one memory device 206 electrically coupled to the electronic processor 204 and having instructions (e.g., a computer program 208) stored therein, the at least one memory device 206 and the instructions configured to, with the at least one processor 204, cause any one or more of the methods described herein to be performed. The controller 201 may have an interface 202 comprising an electrical input/output I/O 210, 212, or an electrical input 210, or an electrical output 212, for receiving information and interacting with external components.

FIG. 2A therefore illustrates a control system 200, wherein the one or more electronic controllers collectively comprise:
at least one electronic processor 204 having an electrical input 210 for receiving information associated with and/or for use in automated parking, for example image data and/or ultrasonic data; and
at least one electronic memory device 206 electrically coupled to the at least one electronic processor 204 and having instructions 208 stored therein;
and wherein the at least one electronic processor 204 is configured to access the at least one memory device 206 and execute the instructions stored therein so as to cause the control system 200 to perform and/or cause performance of any one or more methods described herein.

Also illustrated in the example of FIG. 2A are one or more input devices 214. In some examples, the one or more input devices 214 comprise at least part of one or more vehicle systems.

Information can be communicated between the one or more input devices 214 and the control system 200 and/or controller 201. There can be any number of intervening elements between the one or more input devices 214 and the control system 200 (including no intervening elements).

In examples, the input device(s) 214 comprise any suitable input device(s) 214, for example at least part of any suitable vehicle system(s).

For example, the input device(s) 214 can comprise one or more systems and/or at least one element/component of one or more systems involved in automated parking/automated parking manoeuvres.

The input device(s) 214 can comprise any suitable input device(s) 214 from which information can be received that can be used in one or more methods described herein.

In examples, the input device(s) 214 comprise one or more sensors, for example, one or more cameras 36 and/or one or more ultrasonic sensors 29.

Accordingly, in examples, image data 12 from one or more cameras 36 and/or ultrasonic data 28 from one or more ultrasonic sensors 29 can be communicated between the input device(s) 214 and the control system 200 and/or controller 201.

Also illustrated in the example of FIG. 2A are one or more output devices 216.

The one or more output devices 216 can comprise any suitable output device(s) 216 having any suitable form.

For example, the one or more output devices 216 can comprise one or more actuators, one or more displays, one or more separate devices and so on.

Information can be communicated between the one or more output devices 216 and the control system 200 and/or controller 201. There can be any number of intervening elements between the one or more output devices 216 and the control system 200 (including no intervening elements).

In examples, at least one or more output devices 216 can be used to provide information to a user, such as a driver of the vehicle 10.

In the illustrated example, the control system 200 is configured to provide one or more outputs 22 to the one or more output devices 216.

For example, one or more outputs 22 can be provided to at least one user of the vehicle 10 informing the at least one user of an imminent kerb strike.

For example, one or more outputs 22 can be provided to at least one user to provide the user with an option to proceed with an automated parking manoeuvre or switch to a manual driving mode.

In examples, the control system 200 is configured to output one or more control signals to control, for example, one or more systems and/or one or more features, and/or functionality of the vehicle 10. For example, the control system 200 can be configured to output one or more control signals to control automated parking functionality of the vehicle 10.

FIG. 2B illustrates a non-transitory computer-readable storage medium 218 comprising the instructions (computer software).

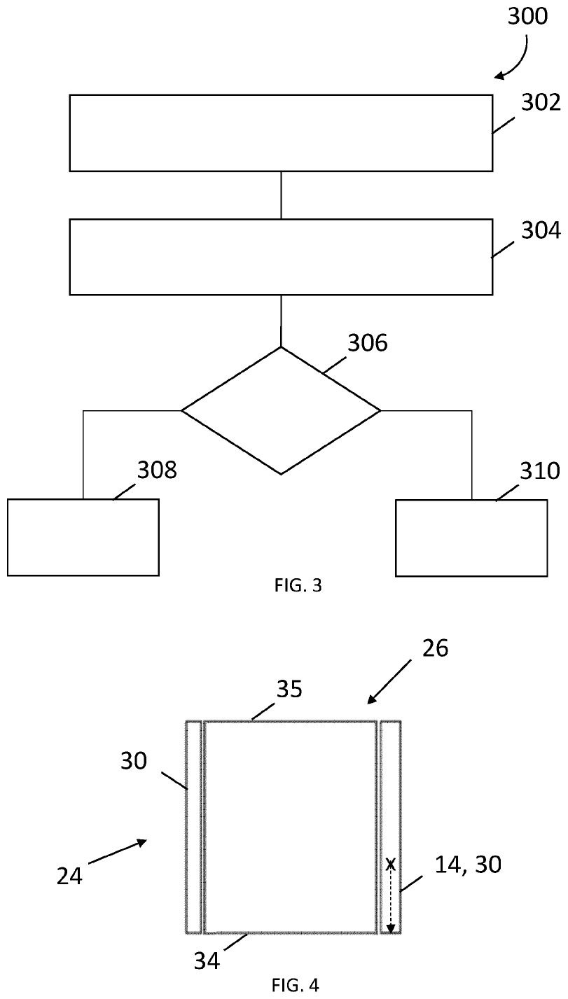

Accordingly, FIG. 2B illustrates a non-transitory computer readable storage medium 218 comprising computer readable instructions 208 that, when executed by a processor 204, cause performance of at least part of a method of one or more of FIG. 3, and/or as described herein.

FIG. 3 illustrates an example of a method 300.

In examples, the method 300 can be considered an automated parking method.

In examples, the method 300 can be considered a method 300 of automatically parking a vehicle 10.

In examples, the method 300 can be considered a method 300 of preventing non-user authorised vehicle kerb strikes.

In examples, the method 300 can be considered a method 300 of automatically controlling parking of a vehicle 10.

In examples, the method 300 can be considered a method 300 of enhancing and/or improving automated parking of a vehicle 10.

In some examples, the method 300 is performed by the control system 200 of FIGS. 2A, 2B.

That is, in some examples, the control system 200 described herein comprises and/or provides means for performing the method 300. However, any suitable means may be used to perform method 300.

Method 300 can be considered a computer implemented method 300 for a vehicle 10, such as the vehicle 10 of FIG. 1.

One or more of the features discussed in relation to FIG. 3 can be found in one or more of the other figures.

At block 302 method 300 comprises receiving image data 12. Receiving image data 12 can be performed in any suitable way using any suitable method.

For example, image data 12 can be received from one or more input devices 214 of FIG. 2A.

For example, receiving image data 12 can comprise receiving one or more signals from one or more input devices 214 of FIG. 2A.

In examples, image data 12 can comprise any suitable image data 12. For example, image data 12 can comprise any suitable image data 12 configured to allow and/or permit and/or enable a determination that at least one kerb 14 is in the vicinity of the vehicle 10 during an automated parking manoeuvre 16.

In examples, image data 12 can be considered data received from one or more cameras 36, for example, one or more cameras 36 of the vehicle 10.

In examples, image data 12 can be considered data that can be processed by one or more image processors implementing computer vision algorithms.

In examples, image data 12 can be considered data that is configured to allow image processing to be performed on the data, for example edge detection.

In examples, image data 12 can be considered data that is configured to allow one or more images to be determined and/or provided, for example, one or more images of the environment of the vehicle 10.

At block 304, method 300 comprises determining, in dependence on, at least, the received image data 12, that a kerb 14 is in the vicinity of the vehicle 10 during an automated parking manoeuvre 16.

As used herein, the term “determining” (and grammatical variants thereof) can include, at least; calculating, computing, processing, deriving, investigating, looking up (for example looking up in a table, a database or another data structure), ascertaining and the like. Also, “determining” can include receiving (for example, receiving information), accessing (for example, accessing data in a memory) and the like. Also, “determining” can include resolving, selecting, choosing, establishing, and the like.

Determining, in dependence on, at least, the received image data 12, that a kerb 14 is in the vicinity of the vehicle 10 during an automated parking manoeuvre 16 can be performed in any suitable way using any suitable method.

In examples, determining, at block 304, comprises analysing and/or processing image data 12 using any suitable image processing method or methods to determine that a kerb 14 is in the vicinity of the vehicle 10 during an automated parking manoeuvre 16.

For example, determining at block 304 can comprise performing edge detection on image data 12 to determine that a kerb 14 is in the vicinity of the vehicle 10 during an automated parking manoeuvre 16.

In some examples, image data 12 is processed and/or analysed frame-by-frame, for example using edge detection, to determine that a kerb 14 is in the vicinity of the vehicle 10 during an automated parking manoeuvre 16.

In examples, determining at block 304 comprises performing edge detection in dependence on the received image data 12 and searching for contours/continuous edges in the image data 12 to determine that a kerb 14 is in the vicinity of the vehicle 10 during an automated parking manoeuvre 16.

In examples, a kerb 14 can be considered a low object positioned to delimit at least one edge 24 of a parking slot 26.

Accordingly, in examples, the kerb 14 delimits at least one edge 24 of a parking slot 26.

In examples, a kerb 14 is an object that is less than 15 centimetres in height and at least 1 metre in length.

In examples, a kerb 14 in the vicinity of the vehicle 10 during an automated parking manoeuvre 16 can be considered to be proximate and/or in proximity of, and/or near, and/or nearby, and/or close to the vehicle 10 during an automated parking manoeuvre 16.

In some examples, a kerb 14 in the vicinity of the vehicle 10 during an automated parking manoeuvre 16 can be considered a kerb 14 that is close enough to the vehicle 10 that the vehicle 10 may interact with the kerb 14 during the automated parking manoeuvre 16, and/or that the position of the kerb 14 is relevant for consideration and/or processing by the vehicle 10 during the automated parking manoeuvre 16.

In some examples, it can be considered that a kerb 14 is in the vicinity of the vehicle 10 during an automated parking manoeuvre 16 if the kerb 14 has a relative position such that the kerb 14 delimits a parking slot 26 and/or the kerb 14 can come into the driving trajectory of the vehicle 10 during the automated parking manoeuvre.

An automated parking manoeuvre 16 can be considered any automated manoeuvre of the vehicle 10 that automatically controls the vehicle 10 to place the vehicle 10 in a parked position.

For example, an automated parking manoeuvre 16 can be considered a manoeuvre that is configured to position the vehicle 10 in a parking slot 26 without input from a driver during the manoeuvre.

A parking slot 26 can also be considered a parking space and can have any suitable form to allow a vehicle 10 to be parked.

In examples, an automated parking manoeuvre 16 can be performed with a driver in the vehicle 10, which can be considered automated parking, and also without a driver in the vehicle 10, which can be considered automated remote parking.

By way of example, reference is made to FIG. 4. FIG. 4 illustrates an example of a parking slot 26.

In the example of FIG. 4, the parking slot 26 has two side edges 30, a front edge 34, and a back edge 35.

In the illustrated example, the side edge 30 on the left of the figure is delimited by a painted line and the side edge 30 to the right of the figure is delimited by a kerb 14.

The front edge 34 of a parking slot 26 can be considered to be delimited by the front of the side edges 30.

The back edge 35 of a parking slot 35 can be considered to be delimited by the back of the side edges 30, and/or the presence of one or more features configured to delimit the back edge 35 of the parking slot 26 such as one or more objects and/or one or more painted lines. In some examples, the back edge 35 of a parking slot 26 can be delimited by one or more kerbs 14.

However, in examples, the parking slot 26 can be delimited in any suitable way.

In examples, the side edges 30 can be considered the edges of the parking slot 26 that are adjacent to the sides of the vehicle 10 when the vehicle 10 is in the parking slot 26.

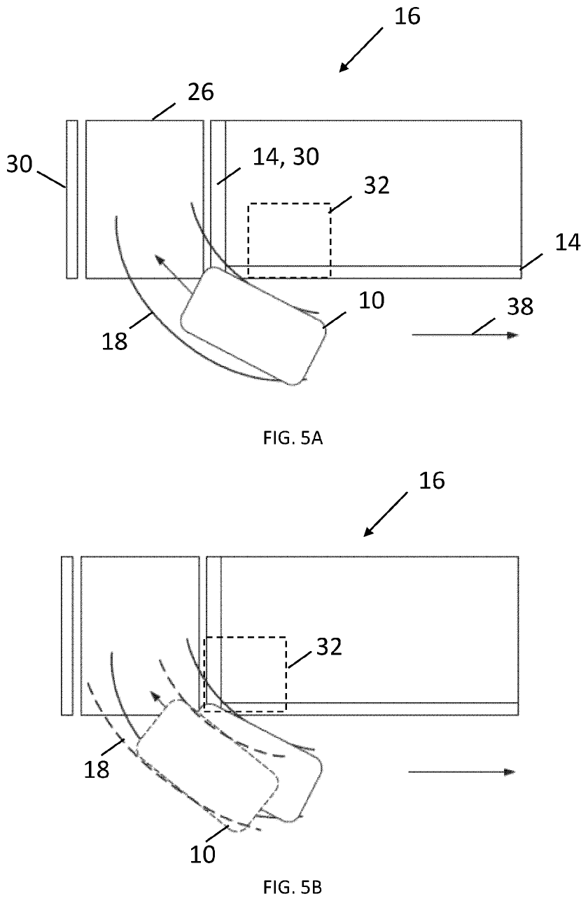

In examples where the side edges 30 are substantially perpendicular to a direction of travel of vehicles past the parking slot 26, the parking slot 26 can be considered a “vertical” parking slot 26. See, for example, FIGS. 5A and 5B.

In examples where the side edges 30 are substantially parallel with the direction of travel of vehicles past the parking slot 26, the parking slot 26 can be considered a “horizontal” parking slot 26.

However, in examples, a parking slot 26 can have any suitable orientation relative to a direction of travel past the parking slot 26.

Returning to the example of FIG. 3, in some examples, method 300 comprises determining that at least one kerb 14 is in the vicinity of the vehicle 10 during an automated parking manoeuvre 16 in dependence on image data 12 and data from one or more other sensors, such as one or more ultrasonic sensors 29.

Accordingly, in examples, method 300 comprises determining that a kerb 14 is in the vicinity of the vehicle 10 during an automated parking manoeuvre 16 in dependence on, at least, image data 12 and ultrasonic data 28. For avoidance of doubt, “determining that a kerb 14 is in the vicinity of the vehicle” includes the possibility of more than one kerb being so determined.

In such examples, image data 12 and data from one or more other sensors, for example ultrasonic data 28, can be used in any suitable way to determine that a kerb 14 is in the vicinity of the vehicle 10 during an automated parking manoeuvre 16.

For example, image data 12 and ultrasonic data 28 can be fused and/or combined in any suitable way to allow a determination that a kerb 14 is in the vicinity of the vehicle 10 during an automated parking manoeuvre 16.

For example, determining that a kerb 14 is in the vicinity of the vehicle 10 during an automated parking manoeuvre 16 in dependence on, at least, image data 12 and ultrasonic data 28 can comprise correlating the presence of a continuous static contour that could be a kerb 14, from the reflections off it coming back to at least one ultrasonic sensor 29, against edge detection from vision data processing, by, for example, way of properties of the pixels, to increase confidence that it is a kerb 14.

In some examples, determining that a kerb 14 is in the vicinity of the vehicle 10 during an automated parking manoeuvre 16 comprises determining that a kerb 14 is in the vicinity of the vehicle 10 between activation of an automated vehicle parking system and deactivation of the automated vehicle parking system.

In some examples, determining that a kerb 14 is in the vicinity of the vehicle 10 during an automated parking manoeuvre 16 comprises determining that a kerb 14 is in the vicinity of the vehicle 10 as the vehicle 10 is being manoeuvred into a parking slot 26

At block 306, method 300 comprises determining whether a projected path 18 of the automated parking manoeuvre 16 of the vehicle 10 will cause the vehicle 10 to strike at least one of the determined kerb(s) 14.

In examples, determining whether a projected path of the automated parking manoeuvre 16 of the vehicle 10 will cause the vehicle 10 to strike a kerb 14 can be performed in any suitable way using any suitable method.

In examples, determining at block 306 comprises determining whether the projected path 18 will cause any portion or portions of the vehicle 10 to come into contact with a kerb 14.

For example, it can be determined that a projected path 18 of the automated parking manoeuvre 16 of the vehicle 10 will cause one or more wheels 20 of the vehicle 10 to come into contact with a kerb 14.

In some examples, block 306 can be considered to comprise determining whether a projected path 18 that the vehicle 10 will move along during the automated parking manoeuvre 16 will cause the vehicle 10 to strike a kerb 14.

In examples, a projected path 18 of the automated parking manoeuvre 16 of the vehicle 10 can be considered a path and/or route and/or course that the vehicle 10 will traverse/move along during the automated parking manoeuvre 16. See, for example, FIGS. 5A and 5B.

In examples, a projected path 18 of the automated parking manoeuvre 16 can be considered a determined path, and/or a calculated path and/or a future path and so on.

Accordingly, in examples, it can be determined and/or predicted that a kerb strike will occur if the vehicle 10 continues along the projected path 18 to be taken by the vehicle 10 during the automated parking manoeuvre 16.

If, at block 306, it is determined that the projected path 18 of the automated parking manoeuvre 16 of the vehicle 10 will not cause the vehicle 10 to strike a kerb 14, method 300 proceeds to block 308.

At block 308, method 300 comprises outputting at least one control signal to control the vehicle 10 to proceed with the automated parking manoeuvre 16.

Accordingly, in examples, method 300 comprises, when it is determined that the projected path 18 of the automated parking manoeuvre 16 of the vehicle 10 will not cause the vehicle 10 to strike a kerb 14, outputting at least one control signal to control the vehicle 10 to proceed with the automated parking manoeuvre 16.

Outputting at least one control signal to control the vehicle 10 to proceed with the automated parking manoeuvre 16 can be performed in any suitable way using any suitable method. For example, one or more control signals can be outputted to any suitable system or systems and/or component or components of the vehicle 10 to control the vehicle 10 to proceed with the automated parking manoeuvre 16.

Accordingly, in examples, at least, image data 12 is monitored and/or processed during an automated parking manoeuvre 16 of the vehicle 10 to check for kerb(s) 14 along the projected path 18 of the vehicle 10 and, if clear, allows the vehicle 10 to complete the automated parking manoeuvre 16 without striking one or more kerbs 14.

If it is determined, at block 306, that the projected path 18 of the automated parking manoeuvre 16 of the vehicle 10 will cause the vehicle 10 to strike a determined kerb 14, method 300 proceeds to block 310.

At block 310, method 300 comprises outputting at least one control signal to control performance of one or more actions to prevent a non-user authorised vehicle kerb strike.

Consequently, FIG. 3 illustrates a method 300 comprising:
receiving image data 12;
determining, in dependence on, at least, the received image data 12, that a kerb 14 is in the vicinity of the vehicle 10 during an automated parking manoeuvre 16;
determining whether a projected path 18 of the automated parking manoeuvre 16 of the vehicle 10 will cause the vehicle 10 to strike the kerb 14;
when it is determined that the projected path 18 of the automated parking manoeuvre 16 of the vehicle 10 will not cause the vehicle 10 to strike the kerb 14, outputting at least one control signal to control the vehicle 10 to proceed with the automated parking manoeuvre 16; and
when it is determined that the projected path 18 of the automated parking manoeuvre 16 of the vehicle 10 will cause the vehicle 10 to strike the kerb 14, outputting at least one control signal to control performance of one or more actions to prevent a non-user authorised vehicle kerb strike.

In examples, outputting at least one control signal to control performance of one or more actions to prevent a non-user authorised kerb strike can be performed in any suitable way using any suitable method. For example, one or more control signals can be outputted to any suitable system or systems and/or component or components of the vehicle 10 to control performance of one or more actions to prevent a non-user authorised kerb strike.

Any suitable action or actions can be performed to prevent a non-user authorised vehicle kerb strike. For example, the one or more actions can comprise changing the projected path 18, and/or interrupting the automated parking manoeuvre 16, and/or stopping the vehicle 10 and/or informing a user of the vehicle 10 of an imminent kerb strike and so on.

A non-user authorised vehicle kerb strike can be considered a kerb strike by one or more parts of the vehicle that occur without authorisation from a user of the vehicle 10, such as a driver of the vehicle 10, that such a kerb strike can be made.

For example, a non-user authorised vehicle kerb strike can be considered a coming together of one or more wheels 20 of the vehicle 10 with one or more kerbs 14 without knowledge of the kerb strike being provided to a user of the vehicle 10 and/or authorisation being provided from a user of the vehicle 10, such as a driver of the vehicle 10, that the vehicle 10 should allow the one or more wheels 20 to come into contact with the one or more kerbs 14.

A non-user authorised vehicle kerb strike can be considered a non-user permitted, and/or a non-user expected and/or a non-user allowed vehicle kerb strike and so on.

In some examples, method 300 comprises determining that at least one wheel 20 of the vehicle 10 has struck a kerb 14 during the automated parking manoeuvre 16, and outputting at least one control signal to control performance of one or more actions in dependence on determining that at least one wheel 20 of the vehicle 10 has struck a kerb 14 during the automated parking manoeuvre 16.

For example, at least one wheel 20 of the vehicle 10 may strike a kerb 14 that was not determined at block 304. A kerb 14 that at least one wheel 20 of the vehicle 10 has struck/come into contact with can at that point onwards be considered a determined kerb 14.

In examples, outputting at least one control signal to control performance of one or more actions in dependence on determining that at least one wheel 20 of the vehicle 10 has struck a kerb 14 during the automated parking manoeuvre 16 can be performed in the same way, and/or similarly to block 310.

Accordingly, the one or more actions performed when it is determined that at least one wheel 20 of the vehicle 10 has struck a kerb 14 during the automated parking manoeuvre 16 can be the same and/or similar to the one or more actions performed in relation to block 310.

Determining that the at least one wheel 20 of the vehicle 10 has struck a kerb 14 during the automated parking manoeuvre 16 can be performed in any suitable way using any suitable method.

For example, determining that at least one wheel 20 of the vehicle 10 has struck a kerb 14 during the automated parking manoeuvre 16 can be performed using a closed feedback loop.

By way of example, reference is made to FIG. 5A.

FIG. 5A illustrates an example of an automated parking manoeuvre 16 of a vehicle 10.

In the example of FIG. 5A, a vehicle 10 is automatically manoeuvring into a parking slot 26.

The example of FIG. 5A, and also FIG. 5B, illustrate a particular parking scenario. However, examples of the disclosure are not limited to such a scenario and can apply to any suitable parking scenario.

For example, any suitable edge(s) of the parking slot 26, for example the left side edge 30, can be delimited by at least one kerb 4, and/or the automated parking manoeuvre 16 can be from the left of the parking slot 26, and/or the parking slot 26 can have any suitable configuration and so on.

In the example of FIG. 5A, the parking slot 26 has side edges 30 to the left and right. To the left, the parking slot 26 is delimited by a painted line and to the right the parking slot 26 is delimited by a kerb 14.

There is also a kerb 14 extending substantially perpendicularly away from the kerb 14 delimiting the right side edge 30 of the parking slot 26 at the front of the side edge kerb.

The projected path 18 of the automated parking manoeuvre 16 of the vehicle 10 is also illustrated in the example of FIG. 5A. In the example of FIG. 5A, the projected path 18 is illustrated by two curved lines indicating the path the vehicle 10 will take as it is automatically manoeuvred into the parking slot 26.

In the example of FIG. 5A, it is determined that a wheel 20 of the vehicle 10 will strike the kerb 14 delimiting the right side edge 30 of the parking slot 26 if the vehicle 10 manoeuvres along the projected path 18.

However, in some examples, it can be determined that a wheel 20 of the vehicle 10 has made contact with/struck the kerb 14 delimiting the right side edge 30 of the parking slot 26 during the automated parking manoeuvre 16 without having been detected and determined by the vehicle control system 200.

Also illustrated in the example of FIG. 5A is the direction of travel 38 of the vehicle 10 past the parking slot 26. Accordingly, in the example of FIG. 5A, the parking slot 26 can be considered a “vertical” parking slot 26.

Referring back to the example of FIG. 3, in some examples, method 300 comprises, when it is determined that the projected path 18 of the automated parking manoeuvre 16 will cause the vehicle 10 to strike the kerb 14 or that at least one wheel 20 of the vehicle 10 has struck a kerb 14, determining if the projected path 18 of the vehicle 10 can be changed to avoid the kerb 14.

In examples, determining if the projected path 18 of the vehicle 10 can be changed to avoid the kerb 14 can be performed in any suitable way using any suitable method.

For example, it can be determined if the projected path 18 of the vehicle 10 can be changed in any way to allow the vehicle 10 to successfully manoeuvre into the parking slot 26 without striking a kerb 14.

In examples, determining if the projected path 18 of the vehicle 10 can be changed to avoid the kerb 14 comprises determining if the projected path 18 of the vehicle 10 can be changed within one or more constraints/restrictions/limitations, to avoid the kerb 14.

The one or more constraints can comprise any suitable constraint or constraints, for example any suitable constraint on the automated parking manoeuvre 16.

For example, it can be determined if the projected path 18 of the vehicle 10 can be changed to avoid the kerb 14 while preventing too many changes to the projected path 18, and/or avoiding contact with one or more other objects in the vicinity of the vehicle 10, such as one or more other vehicles, and/or without bringing the vehicle 10 too close to passing traffic and/or without contacting another kerb that may be determined, and so on.

Accordingly, in some examples, when it is determined that the projected path 18 of the automated parking manoeuvre 16 will, or has, caused the vehicle to the kerb 14 it is determined if the projected path 18 of the vehicle 10 can be changed in any suitable way to allow the vehicle 10 to perform the automated parking manoeuvre 16 while avoiding a kerb strike and/or mounting or driving over at least one kerb 14.

In some examples, method 300 comprises, when it is determined that the projected path 18 can be changed to avoid the kerb 14, changing the projected path 18 of the automated parking manoeuvre 16 of the vehicle 10 to avoid the kerb 14.

By way of example, reference is made to FIG. 5B.

FIG. 5B shows an example of the automated parking manoeuvre 16 illustrated in the example of FIG. 5A at a later time.

In the example of FIG. 5B, it has been determined that the projected path 18 can be changed to avoid the kerb strike and the updated projected path 18 is illustrated by the dashed curved lines.

Accordingly, it can be seen from the examples of FIGS. 5A and 5B that the kerb 14 delimiting the parking slot 26 can be determined and thus avoided whilst still allowing the automated parking manoeuvre 16 to proceed successfully.

In examples, the projected path 18 of the automated parking manoeuvre 16 of the vehicle 10 can be changed in any suitable way to avoid the at least one of the determined at least one kerb 14.

For example, the projected path 18 can be re-determined and/or re-calculated to allow the vehicle 10 to be automatically parked in the parking slot 26 while avoiding striking and/or mounting the kerb 14.

Returning to the example of FIG. 3, in some examples, method 300 comprises, when it is determined that the projected path 18 cannot be changed to avoid the kerb 14, interrupting the automated parking manoeuvre 16 and providing at least one output 22 to at least one user of the vehicle 10, such as a driver of the vehicle 10, informing the at least one user of an imminent kerb strike.

For example, when it is determined that there is no projected path 18 that will avoid the at least one determined at least one kerb 14, without violating one or more other constraints, the user can be informed of the imminent kerb strike.

In examples, providing at least one output 22 to at least one user of the vehicle 10 informing the at least one user of an imminent kerb strike can be performed in any suitable way using any suitable method.

For example, any suitable output(s) 22 to at least one user of the vehicle 10 can be made. In examples, the at least one output 22 can be made via any suitable human machine interface of the vehicle 10 and/or separate to the vehicle 10.

For example, the at least one output 22 can be made via at least one display of the vehicle 10 and/or a device, such as a mobile phone, of the user.

In some examples, method 300 comprises providing to the at least one user an option to proceed with the automated parking manoeuvre 16 or switch to a manual driving mode.

Referring again to the example of FIG. 5A, when it is determined that the projected path 18 cannot be changed to avoid the kerb 14, the automated parking manoeuvre 16 is interrupted and at least one output 22 provided to the driver of the vehicle 10 to inform the driver of the imminent kerb strike and to provide an option to proceed with the automated parking manoeuvre 16 or switch to a manual driving mode.

Accordingly, in such examples, a user of the vehicle 10 can authorise the vehicle 10 to continue with the automated parking manoeuvre 16 with the knowledge that doing so will cause the vehicle 10 to strike and/or mount at least one kerb during the manoeuvre 16 or can switch to a manual driving mode to allow, for example, the user to park the vehicle 10.

Referring back to FIG. 3, in examples, method 300 comprises determining a potential parking slot for use in an automated parking manoeuvre 16.

A potential parking slot can be determined in any suitable way using any suitable method. For example, a potential parking slot can be determined in dependence on data and/or information received from one or more sensors of the vehicle 10 as the vehicle 10 drives by the potential parking slot.

For example, in the example of FIG. 5A, the vehicle 10 may drive by the parking slot 26 in the direction 38 and, in dependence on information/data received from one or more sensors of the vehicle 10, it can be determined that the parking slot 26 is a potential parking slot.

In some examples, method 300 comprises determining that at least one side edge 30 of a potential parking slot is not delimited and positioning a virtual object 32 to create an artificial demarcation to define an area to be avoided by the vehicle 10 during the automated parking manoeuvre 16.

Referring again to the example of FIG. 5A, in examples, it has been determined that the parking slot 26 is a potential parking slot but it has not been possible to identify the kerb 14 delimiting the right side edge 30 as the vehicle 10 drove passed the potential parking slot.

Accordingly, in examples, a virtual object 32 is placed to create an artificial demarcation to define an area to be avoided by the vehicle 10 during the automated parking manoeuvre 16.

The virtual object 32 can be placed and/or created in any suitable way.

In examples, the virtual object 32 is placed a predetermined and/or standard distance away from a known delimitation of the parking slot 26. For example, the virtual object 32 can be placed a predetermined distance from the line delimiting the left side edge of the parking slot 26.

Returning to the example of FIG. 3, in some examples, method 300 comprises, when it is determined that the projected path 18 of the automated parking manoeuvre 16 will cause the vehicle 10 to strike the kerb 14 or that at least one wheel 20 of the vehicle 10 has struck a kerb 14, extending the determined at least one kerb 14 as a line for delimiting the parking slot 26.

Extending the kerb 14 as a line for delimiting the parking slot 26 can be performed in any suitable way using any suitable method.

In examples, the anticipated point of contact or point of contact with the kerb 14 can be extended in line with a front edge 34 of the parking slot 26 as a line for delimiting the parking slot 26.

By way of example, reference is made to the example of FIG. 4.

In the example of FIG. 4, an “X” marks a spot at which it is determined that the vehicle 10 will strike the kerb 14 or that the at least one wheel 20 of the vehicle 10 has struck the kerb 14 and the kerb 14 has been extended virtually in line with the front edge 34 of the slot 26 as indicated by the dashed arrow.

Referring again to the example of FIG. 3, in some examples, method 300 comprises repositioning the virtual object 32 to cover the extended kerb 14, while aligning the repositioned virtual object 32 with a front edge 34 of a parking slot 26 that the vehicle 10 is manoeuvring into.

Reference is again made to the example of FIG. 5A.

In the example of FIG. 5A a virtual object 32 has been positioned, however it is determined during the automated parking manoeuvre 16 that the projected path 18 of the automated parking manoeuvre 16 will cause the vehicle 10 to strike the determined kerb 14. This may be before the parking manoeuvre is performed or, if the kerb was not previously determined, after an unauthorised kerb strike and repositioning of the vehicle.

Accordingly, in examples, the kerb 14 is extended as a line for delimiting the parking slot 26 and the virtual object 32 repositioned to cover the extended at least one kerb 14 while aligning the repositioned virtual object 32 with a front edge 34 of the parking slot 26.

This can be seen in the example of FIG. 5B in which the virtual object 32 has been repositioned to cover the extended kerb 14 while aligning the repositioned virtual object 32 with a front edge 34 of the parking slot 26 that the vehicle 10 is manoeuvring into.

In examples, the changed projected path 18 of the automated parking manoeuvre 16 can be determined in dependence on the position of the repositioned virtual object 32.

In examples, method 300 can be triggered, and/or started, and/or commenced in dependence on any suitable input(s) and/or determination(s), and/or circumstances, and/or constraints.

In some examples, method 300 can be triggered in dependence on determining that at least one side edge 30 of a potential parking slot 26 is not delimited.

Accordingly, in examples, method 300 comprises determining that at least one side edge 30 of a potential parking slot 26 is not delimited wherein at least one method as described herein is performed in dependence on the determination that at least one side edge 30 of a potential parking slot 26 is not delimited.

For example, in the example of FIG. 5A/5B, when the vehicle 10 drives past the potential parking slot 26 it can be determined that the right side edge 30 is not delimited as it has not been able to identify and/or detect the kerb 14 and therefore method 300 can be performed in dependence on the determination.

Method 300 is advantageous and provides one or more technical benefits.

For example, method 300 provides for preventing a vehicle from striking a kerb or kerbs during an automated parking manoeuvre without driver/user knowledge and/or approval.

For example, method 300 provides for avoiding striking at least one kerb during an automated parking manoeuvre if possible, or informing a user/driver of the vehicle if avoiding the kerb is not possible.

For example, method 300 provides for avoiding damage to the vehicle, for example to tyres and/or wheel rims of the vehicle.

For example, method 300 potentially provides for avoiding parking a vehicle over a kerb in a position from which it becomes potentially illegal to park based on road traffic rules, and/or difficult/unsafe to the user to access the vehicle and its contents.

For example, method 300 provides for avoiding rework by a user of the vehicle, such as a driver of the vehicle, to manually adjust the parking of the vehicle.

It is to be understood that the or each controller 200 can comprise a control unit or computational device having one or more electronic processors (e.g., a microprocessor, a microcontroller, an application specific integrated circuit (ASIC), etc.), and may comprise a single control unit or computational device, or alternatively different functions of the or each controller 200 may be embodied in, or hosted in, different control units or computational devices. As used herein, the term “controller,” “control unit,” or “computational device” will be understood to include a single controller, control unit, or computational device, and a plurality of controllers, control units, or computational devices collectively operating to provide the required control functionality. A set of instructions could be provided which, when executed, cause the controller 200 to implement the control techniques described herein (including some or all of the functionality required for the method described herein). The set of instructions could be embedded in said one or more electronic processors of the controller 200; or alternatively, the set of instructions could be provided as software to be executed in the controller 200. A first controller or control unit may be implemented in software run on one or more processors. One or more other controllers or control units may be implemented in software run on one or more processors, optionally the same one or more processors as the first controller or control unit. Other arrangements are also useful.

In the example illustrated in FIG. 2A, the or each controller 200 comprises at least one electronic processor 204 having one or more electrical input(s) 210 for receiving one or more input signal(s) and one or more electrical output(s) 212 for outputting one or more output signal(s). The or each controller 200 further comprises at least one memory device 206 electrically coupled to the at least one electronic processor 204 and having instructions 208 stored therein. The at least one electronic processor 204 is configured to access the at least one memory device 206 and execute the instructions 208 thereon so as to, for example, determine, in dependence on, at least, received image data, that a kerb is in the vicinity of the vehicle during an automated parking manoeuvre; and determine whether a projected path of the automated parking manoeuvre of the vehicle will cause the vehicle to strike the kerb.

The, or each, electronic processor 204 may comprise any suitable electronic processor (e.g., a microprocessor, a microcontroller, an ASIC, etc.) that is configured to execute electronic instructions. The, or each, electronic memory device 206 may comprise any suitable memory device and may store a variety of data, information, threshold value(s), lookup tables or other data structures, and/or instructions therein or thereon. In an embodiment, the memory device 206 has information and instructions for software, firmware, programs, algorithms, scripts, applications, etc. stored therein or thereon that may govern all or part of the methodology described herein. The processor, or each, electronic processor 204 may access the memory device 206 and execute and/or use that or those instructions and information to carry out or perform some or all of the functionality and methodology describe herein.

The at least one memory device 206 may comprise a computer-readable storage medium (e.g. a non-transitory or non-transient storage medium) that may comprise any mechanism for storing information in a form readable by a machine or electronic processors/computational devices, including, without limitation: a magnetic storage medium (e.g. floppy diskette); optical storage medium (e.g. CD-ROM); magneto optical storage medium; read only memory (ROM); random access memory (RAM); erasable programmable memory (e.g. EPROM ad EEPROM); flash memory; or electrical or other types of medium for storing such information/instructions.

Example controllers 200 have been described comprising at least one electronic processor 204 configured to execute electronic instructions stored within at least one memory device 206, which when executed causes the electronic processor(s) 204 to carry out the method as hereinbefore described. However, it will be appreciated that embodiments of the present invention can be realised in any suitable form of hardware, software or a combination of hardware and software. For example, it is contemplated that the present invention is not limited to being implemented by way of programmable processing devices, and that at least some of, and in some embodiments all of, the functionality and or method steps of the present invention may equally be implemented by way of non-programmable hardware, such as by way of non-programmable ASIC, Boolean logic circuitry, etc.

It will be appreciated that various changes and modifications can be made to the present invention without departing from the scope of the present application.

The blocks illustrated in FIG. 3 may represent steps in a method and/or sections of code in the computer program 208. The illustration of a particular order to the blocks does not necessarily imply that there is a required or preferred order for the blocks and the order and arrangement of the block may be varied. Furthermore, it may be possible for some steps to be omitted.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A control system for a vehicle, the control system comprising one or more controllers, wherein the control system is configured to:
receive image data;
determine, in dependence on, at least, the received image data, that a kerb is in the vicinity of the vehicle during an automated parking manoeuvre;
determine whether a projected path of the automated parking manoeuvre of the vehicle will cause the vehicle to strike the kerb;
when it is determined that the projected path of the automated parking manoeuvre of the vehicle will not cause the vehicle to strike the kerb, output at least one control signal to control the vehicle to proceed with the automated parking manoeuvre; and
when it is determined that the projected path of the automated parking manoeuvre of the vehicle will cause the vehicle to strike the kerb, output at least one control signal to control performance of one or more actions to prevent a non-user authorised vehicle kerb strike.

2. The control system of claim 1, wherein the control system is configured to output at least one control signal to control performance of one or more actions in dependence on determining that at least one wheel of the vehicle has struck a kerb during the automated parking manoeuvre.

3. The control system of claim 1, wherein the control system is configured to, when it is determined that the projected path of the automated parking manoeuvre will cause the vehicle to strike the kerb or that at least one wheel of the vehicle has struck a kerb, determine if the projected path of the vehicle can be changed to avoid the kerb.

4. The control system of claim 3, wherein the control system is configured to,
when it is determined that the projected path can be changed to avoid the kerb, change the projected path of the automated parking manoeuvre of the vehicle to avoid the kerb and/or
when it is determined that the projected path cannot be changed to avoid the kerb, interrupt the automated parking manoeuvre and provide at least one output to at least one user of the vehicle informing the at least one user of an imminent kerb strike.

5. The control system of claim 4, wherein the control system is configured to provide to the at least one user, an option to proceed with the automated parking manoeuvre or switch to a manual driving mode.

6. The control system of claim 1, wherein the control system is configured to determine that at least one kerb is in the vicinity of the vehicle during the automated parking manoeuvre in dependence on, at least, image data and ultrasonic data.

7. The control system of claim 1, wherein the control system is configured to determine that at least one side edge of a potential parking slot is not delimited and to position a virtual object to create an artificial demarcation to define an area to be avoided by the vehicle during the automated parking manoeuvre.

8. The control system of claim 7, wherein the control system is configured to, when it is determined that the projected path of the automated parking manoeuvre will cause the vehicle to strike the kerb or that at least one wheel of the vehicle has struck a kerb, extend the kerb virtually as a line for delimiting the potential parking slot and reposition the virtual object to cover the extended kerb, while aligning the repositioned virtual object with a front edge of a parking slot that the vehicle is manoeuvring into.

9. A vehicle comprising the control system as claimed in claim 1 and at least one camera configured to output the image data.

10. A method of controlling a vehicle, the method comprising:
receiving image data;
determining, in dependence on, at least, the received image data, that at least one kerb is in the vicinity of the vehicle during an automated parking manoeuvre;
determining whether a projected path of the automated parking manoeuvre of the vehicle will cause the vehicle to strike the kerb;
when it is determined that the projected path of the automated parking manoeuvre of the vehicle will not cause the vehicle to strike the kerb, outputting at least one control signal to control the vehicle to proceed with the automated parking manoeuvre; and
when it is determined that the projected path of the automated parking manoeuvre of the vehicle will cause the vehicle to strike the kerb, outputting at least one control signal to control performance of one or more actions to prevent a non-user authorised vehicle kerb strike.

11. The method of claim 10, comprising, when it is determined that the projected path of the automated parking manoeuvre will cause the vehicle to strike the kerb, determining if the projected path of the vehicle can be changed to avoid the kerb.

12. The method of claim 11, comprising,
when it is determined that the projected path can be changed to avoid the kerb, changing the projected path of the automated parking manoeuvre of the vehicle to avoid the kerb; and/or
when it is determined that the projected path cannot be changed to avoid the kerb, interrupting the automated parking manoeuvre and providing at least one output to at least one user of the vehicle informing the at least one user of an imminent kerb strike.

13. The method of claim 12, comprising, when it is determined that the projected path cannot be changed to avoid the kerb, providing to the at least one user, an option to proceed with the automated parking manoeuvre or switch to a manual driving mode.

14. The method of claim 10, comprising determining that at least one kerb is in the vicinity of the vehicle during the automated parking manoeuvre in dependence on, at least, image data and ultrasonic data.

15. A non-transitory computer readable medium comprising computer readable instructions that, when executed by a processor, cause performance of the method according to claim 10.
